(19) United States
(12) Patent Application Publication
(10) Pub. No.: US 2025/0108358 A1
(43) Pub. Date: Apr. 3, 2025

(54) PHOTOCHEMICALLY DRIVEN REGENERATION OF CARBON DIOXIDE SORBENTS

(71) Applicant: UT-Battelle, LLC, Oak Ridge, TN (US)

(72) Inventors: Yingzhong Ma, Oak Ridge, TN (US); Uvinduni Premadasa, Oak Ridge, TN (US); Radu Custelcean, Knoxville, TN (US); Vera Bocharova, Knoxville, TN (US); Diana Stamberga, Lenoir City, TN (US); Vyacheslav Bryantsev, Knoxville, TN (US); Yi Liao, Melbourne, FL (US); Benjamin L. Doughty, Knoxville, TN (US)

(21) Appl. No.: 18/899,069

(22) Filed: Sep. 27, 2024

Related U.S. Application Data
(60) Provisional application No. 63/541,085, filed on Sep. 28, 2023.

(51) Int. Cl. B01J 20/34; B01J 20/22

(52) U.S. Cl. CPC B01J 20/3441; B01J 20/22

(57) ABSTRACT

A method for regenerating a carbon dioxide (CO₂) sorbent material, the method comprising: (i) contacting a sorbent-CO₂ complex in an aqueous solution containing a reversible photoacid, wherein the CO₂ in the sorbent-CO₂ complex is in the form of bicarbonate, carbonate, or carbamate; and (ii) exposing the aqueous solution to electromagnetic radiation having a wavelength that induces proton release from the photoacid and subsequent protonation of the bicarbonate, carbonate, or carbamate in the sorbent-CO₂ complex to result in release of CO₂ and water and regeneration of the sorbent material. The method may also include re-using the regenerated sorbent to capture carbon dioxide. The sorbent may be, for example, an amino acid (e.g., glycine), alkylamine, alkanolamine, or alkali hydroxide. The reversible photoacid may more particularly be a metastable-state photoacid.

### CROSS-REFERENCE TO RELATED APPLICATIONS

The present application claims benefit of U.S. Provisional Application No. 63/541,085 filed Sep. 28, 2023, all of the contents of which are incorporated herein by reference.

### STATEMENT REGARDING FEDERALLY SPONSORED RESEARCH

This invention was made with government support under Prime Contract No. DE-AC05-00OR22725 awarded by the U.S. Department of Energy. The government has certain rights in the invention.

### FIELD OF THE INVENTION

The present invention generally relates to methods for regenerating carbon dioxide sorbent materials with simultaneous release and storage or usage of the captured carbon dioxide. The invention is particularly directed to the regeneration of sorbent materials, such as those based on amino acids, alkylamines, alkanolamines, alkali hydroxides, and bis(iminoguanidine)s.

### BACKGROUND

Direct air capture (DAC) of carbon dioxide (CO₂) provides a unique opportunity for restoring the atmospheric CO₂ concentration to an optimal level while mitigating climate change. While a number of promising DAC systems have been demonstrated over the past decade based on aqueous solvents or solid adsorbents, regeneration of CO₂-capture solvent/sorbents in DAC processes is becoming a significant part of the overall operational cost (˜70% of total operating cost) in continuous DAC processes. For this reason, more efficient regeneration is sought to permit solvent reuse and sustain stable CO₂ capture performance over time. Current research efforts on efficient regeneration have been mainly focused on developing low-energy-regeneration solvents and sorbents and their potential use in traditional temperature-swing processes. Although conductive heating systems are well-matured for large scale implementation, conventional solvent regeneration by conductive heating is often inefficient, especially for traditional aqueous solvents (e.g., 30 wt % monoethanolamine (MEA)), due to non-uniform heating and overheating, which also leads to solvent degradation. In general, CO₂ desorption from aqueous solvents occurs with diluent evaporation, resulting in a high energy penalty. Thus, there would be a significant benefit in a method that could regenerate CO₂ sorbents in a more energy efficient manner.

### SUMMARY

The present disclosure is foremost directed to a method for regenerating a carbon dioxide (CO₂) sorbent material by a more energy efficient process than conventional processes used in the art. The method includes the following steps: (i) contacting a sorbent-CO₂ complex in an aqueous solution containing a reversible photoacid, wherein the CO₂ in the sorbent-CO₂ complex is in the form of bicarbonate, carbonate, or carbamate; and (ii) exposing the aqueous solution to electromagnetic radiation having a wavelength that induces proton release from the photoacid with subsequent protonation of the bicarbonate, carbonate, or carbamate in the sorbent-CO₂ complex to result in release of CO₂ and water along with regeneration of the carbon dioxide sorbent material. Ways in which the step (i) can be achieved are further discussed in the detailed description section. The regenerated carbon dioxide sorbent material can then be re-used to capture (absorb) additional CO₂ to form additional sorbent-CO₂ complex, which can then be subjected to steps (i) and (ii) above to continue the cycle of CO₂ absorption followed by CO₂ release and regeneration of CO₂ sorbent material. The CO₂ sorbent material may be, for example, a solid or liquid sorbent system.

In some embodiments, the sorbent-CO₂ complex is a solid (e.g., crystalline or non-crystalline) complex with the capacity to be dissolved in an aqueous-based solvent or solution. In other embodiments, the sorbent-CO₂ complex is a solution of the complex. In some embodiments, the carbon dioxide sorbent material is an amine-containing sorbent, or more particularly, an amino acid, alkylamine, alkanolamine, or bis(iminoguanidinium) sorbent material. In some embodiments, the reversible photoacid is a metastable-state reversible photoacid.

In particular embodiments, and as further discussed in the Examples, the present disclosure demonstrates the feasibility of photochemically-driven CO₂ release using a reversible metastable-state photoacid (mPAH) for direct air capture. Through systematic pH measurements on mPAH and a series of reaction mixtures combining mPAH with imidazole, potassium bicarbonate, and CO₂-loaded glycine or other sorbent, it has herein been revealed that the light-driven pH changes in the presence of mPAH facilitate conversion of total inorganic carbon to CO₂ with an efficiency of 55% and about 68%-78% with respect to their initial concentrations in the simulated and amino acid (AA)-based DAC systems, respectively. The feasibility of this photochemically driven CO₂ release in these DAC systems was confirmed using NMR spectroscopy, total inorganic carbon analysis, gaseous CO₂ detection and TGA-MS. The present disclosure further demonstrates the benefits of using the chemical reversibility of mPAH by evaluating its capability for subsequent CO₂ releases. Long-lived deprotonated states, which are unique for this mPAH, permit macroscopic CO₂ release to be achieved at a relatively low concentration of mPAH.

### BRIEF DESCRIPTION OF THE DRAWINGS

FIG. 1. Schematic diagram showing an exemplary direct air capture (DAC) mechanism based on an amino acid (AA) sorbent (glycine shown) and metastable-state reversible photoacid (mPAH 1) for CO₂ release. The arrows labelled as (1) correspond to reactions in a glycine-CO₂ system. Arrows labelled as (3) and (2) indicate anticipated reactions under irradiation and dark conditions, respectively. Some reaction pathways are not depicted for simplicity.

FIGS. 2a-2b. pH measurements as a function of time during light off-on-off steps for a sample containing 1 mM mPAH 1 (FIG. 2a). The numberings denote the timepoints where absorption spectra shown in FIG. 2b were taken to identify the dominant conformations of the mPAH 1.

FIGS. 3a-3b. pH measurements as a function of time in darkness and with light irradiation for a sample containing 1 mM mPAH 1 and 1 mM KHCO₃ (FIG. 3a) and a sample containing 1 mM mPAH 1 and 1 mM imidazole (FIG. 3b). The numberings (1-3) and (4-5) denote the timepoints where the corresponding absorption spectra shown in FIG. 3c and FIG. 3d were taken under dark and irradiation, respectively. These spectra were taken to identify the dominant conformers of the mPAH 1 during the reaction events as detailed below. FIG. 3e shows a photograph of the airtight cuvettes containing aqueous solutions of 1 mM mPAH 1 (right) and 1 mM mPAH 1+1 mM KHCO₃ (left) after exposure to the 355 nm lamp.

FIG. 4. Graph showing CO₂ sampled from the headspace of a reactor containing a mixture of 1 mM KHCO₃ and 1 mM mPAH 1. Initially, nitrogen was purged into the headspace to ensure calibration of the CO₂ sampling data logger, and a clear increase in the CO₂ content was found upon irradiation.

FIGS. 5a-5d. FIGS. 5a and 5c are pH curves for subsequent cycles of irradiation of a solution containing 1 mM mPAH 1 and 1 mM KHCO₃. FIGS. 5b and 5d show the corresponding absorption spectra taken right before each cycle. C₁, C₂, and C₃ refer to first, second, and third cycles of irradiation, respectively.

FIGS. 6a-6b. FIG. 6a is a graph showing pH measurements as a function of light exposure time for a sample containing 1 mM mPAH 1 and 1 mM CO₂-loaded glycine. The numberings denote the time points where absorption spectra shown in (FIG. 6b) were taken to identify the dominant conformations of the mPAH 1.

FIG. 7. ¹³C NMR from a 1:1 mixture of 20 mM glycine/CO₂ and mPAH 1 before and after irradiation. Peaks arising from glycine are labeled and those without labels are from mPAH 1.

FIG. 8. CO₂ sampled from the headspace of a reactor containing a mixture of 1 mM CO₂ loaded glycine and 1 mM mPAH 1. Initially, nitrogen was purged into the headspace to ensure calibration of the CO₂ sampling data logger, and a clear increase in the CO₂ content was found upon irradiation in three repeated cycles.

FIG. 9. Scheme showing the photoreaction process of a sulfonated indazole photoacid referred to herein as “mPAH 2”.

FIGS. 10a-10b. FIG. 10a shows absorption spectra of mPAH 2 in water before and after irradiation. FIG. 10b shows absorption spectra of the photoproduct of mPAH 2, in acetic acid solution (cis-H), and SP generated by addition of base.

FIG. 11. ¹H NMR of mPAH 2, which is a mixture of trans and SP configurations, and morpholine in water. (NMR of mPAH 2 itself in water (trans) is shown in the inset for comparison. For the sake of clarity, only the integrations of three pairs of peaks are listed to show the ratio of trans and SP is about 5:4.).

FIG. 12. The left portion of FIG. 12 is a graph showing head space CO₂ concentration change upon irradiation to the mPAH 2 morpholine solution. The right portion of FIG. 12 depicts the setup of the CO₂ measurement.

FIG. 13. Scheme showing the synthesis of mPAH 2.

### DETAILED DESCRIPTION

The carbon dioxide sorbent material (i.e., “sorbent material”) can be any of those materials known in the art that absorb (capture) the carbon dioxide in the form of bicarbonate, carbonate, or carbamate. The resulting sorbent-CO₂ complex may be a solid or liquid with the capacity to be dissolved in an aqueous-based solvent or solution.

In some embodiments, the carbon dioxide sorbent material is or includes an amine-containing sorbent material. Amine-containing sorbent materials are well known in the art. The term “amine-containing sorbent,” as used herein, refers to amine-containing or ammonium-containing materials that form a complex with (i.e., absorb or capture) carbon dioxide, wherein the CO₂ in the sorbent-CO₂ complex is in the form of bicarbonate, carbonate, or carbamate.

In one set of embodiments, the amine-containing sorbent is or includes an amino acid. Any amino acid, including natural and non-natural amino acids, can function as a carbon dioxide sorbent, although some amino acids may function better than others. The amino acid may be an alpha- or beta-amino acid, or a derivative or mimic of an amino acid (e.g., taurine). Some examples of suitable amino acids include glycine, sarcosine, alanine, beta-alanine (3-aminopropanoic acid), valine, leucine, isoleucine, serine, threonine, glutamine, asparagine, glutamic acid, aspartic acid, lysine, histidine, arginine, phenylalanine, tyrosine, proline, and tryptophan, and N-alkyl derivatives, ester derivatives, or salts of any of the foregoing amino acids. In some embodiments, the amino acid is selected from glycine and/or N-alkylglycines, wherein the alkyl group is independently selected from hydrocarbon groups containing 1-6 carbon atoms (e.g., methyl, ethyl, n-propyl, isopropyl, n-butyl, isobutyl, sec-butyl, t-butyl, n-pentyl, isopentyl, n-hexyl, and isohexyl). Some examples of N-alkylglycines include sarcosine (where the N-alkyl group is methyl) and N-methylalanine.

In other embodiments, the amine-containing sorbent is an alkylamine. The alkylamine may, in some embodiments, be a hydrophobic amine that can dissolve in an organic (non-aqueous) solvent (NAS) or low-aqueous solvent (LAS). In other embodiments, the alkylamine can dissolve in an aqueous solution. The alkylamine typically has the formula NR^{d}R^{e}R^{f}, wherein R^{d}, R^{e}, and R^{f} are selected from H and hydrocarbon groups containing one or more carbon atoms, wherein one, two, or all three of R^{d}, R^{e}, and R^{f} are selected from hydrocarbon groups. The hydrocarbon groups may independently contain 1, 2, 3, 4, 5, 6, 7, 8, 9, 10, 11, or 12 carbon atoms and may or may not contain one or more heteroatoms selected from O, N, and S. In different embodiments, the hydrocarbon groups contain 1-12, 1-6, 1-4, 1-3, 2-12, 2-6, 2-4, or 2-3 carbon atoms. The hydrocarbon groups may be linear or branched alkyl or alkenyl groups or saturated or unsaturated monocyclic or bicyclic groups. Some examples of hydrocarbon groups include methyl, ethyl, n-propyl, isopropyl, n-butyl, isobutyl, n-pentyl, n-hexyl, isohexyl, n-octyl, 2-ethylhexyl, 2-ethyloctyl, n-decyl, n-dodecyl, cyclohexyl, phenyl, pyridyl, and tolyl groups.

In other embodiments, the amine-containing sorbent is an alkanolamine. Alkanolamines are well known in the art for carbon dioxide capture. Some examples of alkanolamines include monoethanolamine, diethanolamine, triethanolamine, diglycolamine, methyldiethanolamine, diisopropanolamine, 2-amino-2-methyl-1-propanol, and 2-(piperidin-2-yl) ethanol.

In the present disclosure, the amine-containing sorbent, such as any of those described above, reacts with carbon dioxide to form a carbamate or an ion pair bond of the formula:

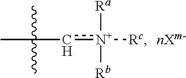

wherein R^{a}, R^{b}, and R^{c} are selected from H and hydrocarbon groups as described above, e.g., containing 1-12 carbon atoms (e.g., methyl and any of the other hydrocarbon groups described above), wherein at least one of R^{a}, R^{b}, and R^{c} is H; the dashed double bond represents the presence or absence of a double bond (i.e., if the dashed double bond is absent, the single bond to R^{c} remains), and the dashed single bond represents the presence or absence of R^{c}, wherein R^{c} is present only if the double bond is not present (or conversely, R^{c} is absent if the double bond is present); X^{m-} is a carbonate (CO₃²⁻) or bicarbonate (HCO₃⁻) anion, with m being 1 for bicarbonate and 2 for carbonate; and n is an integer of 1 or 2, provided that n×m=2.

More specifically, the ion pair bond has any of the following two formulas:

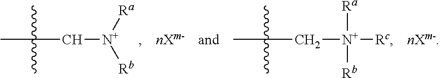

In other embodiments, the carbon dioxide sorbent is an alkali hydroxide. Some examples of alkali hydroxides include lithium hydroxide, sodium hydroxide, and potassium hydroxide. As well known, alkali hydroxides react with carbon dioxide to produce alkali carbonates according to the following reaction scheme: 2MOH+CO₂→M₂CO₃+H₂O, wherein M is an alkali metal ion (e.g., Na⁺ or K⁺). In some embodiments, carbon dioxide is first converted to carbonate or bicarbonate by contact with an initial quick-absorbing sorbent, such as MOH, followed by capture of the carbonate or bicarbonate with an amine or ammonium-containing sorbent, such as any of these described above.

In the method for regenerating a carbon dioxide sorbent material, a sorbent-CO₂ complex containing CO₂ in the form of carbonate or bicarbonate, as described above, is first contacted with a reversible photoacid in aqueous solution. The foregoing contacting step may be referred to as step (i). Notably, the contacting step can be done by, for example, mixing a solution of the sorbent-CO₂ complex with an aqueous solution of the photoacid, or adding a photoacid (in solid or solution form) to a solution of the sorbent-CO₂ complex, or dissolving a solid sorbent-CO₂ complex in a solution followed by addition of a photoacid to the solution (wherein the photoacid can be added as a solution or in solid form), or adding a solution containing the sorbent-CO₂ complex to an aqueous solution containing the photoacid. The contacting step may also include the possibility that the sorbent is in the presence of the photoacid when the sorbent is contacted with CO₂ to produce the sorbent-CO₂ complex, i.e., the sorbent-CO₂ complex may be produced in situ in the presence of the photoacid before the photoacid is exposed to electromagnetic radiation in step (ii) to release the CO₂ and regenerate the sorbent. For example, the contacting step may be practiced by producing an aqueous solution containing the sorbent and photoacid, followed by contacting the aqueous solution with a gaseous source containing carbon dioxide to produce the sorbent-CO₂ complex in the presence of the photoacid in the aqueous solution, before proceeding with step (ii), exposure of the photoacid to electromagnetic radiation. The final aqueous solution in which the sorbent-CO₂ complex is contacted with (or in the presence of) the photoacid may contain only water as the solvent or may contain water in admixture with a water-miscible organic solvent (e.g., an alcohol, acetone, acetonitrile, THF, or DMF) as the solvent.

The term “photoacid,” as used herein, refers to molecules that release a proton in solution upon exposure to an electromagnetic (EM) wavelength that induces (stimulates) proton release in the molecule. For purposes of the present invention, the photoacid molecule is reversible. By being reversible, the photoacid molecule is capable of the reversible transfer of a proton, i.e., the photoacid molecule releases a proton followed by regaining a proton upon cessation of exposure to the stimulating electromagnetic wavelength. Thus, for purposes of the present invention, the photoacid is not a photoacid generator (PAG), since PAGs undergo irreversible proton transfer. In some embodiments, the reversible photoacid is also a metastable-state photoacid, as well known in the art. The photoacid may be stimulated to release a proton at any suitable EM wavelength, dependent on the type of photoacid. The stimulating EM wavelength may be, for example, in the visible, ultraviolet, or infrared range, e.g., 300-800 nm, 350-800 nm, 400-800 nm, 300-700 nm, 350-700 nm, 400-700 nm, 300-600 nm, 350-600 nm, or 400-600 nm.

In some embodiments, the reversible photoacid contains at least one aromatic or heteroaromatic ring or fused ring system. An example of an aromatic ring includes the benzene ring. Some examples of aromatic ring systems include naphthalene, anthracene, phenanthrene, and pyrene ring systems. Some examples of heteroaromatic rings include pyridine, pyrazine, pyrimidine, pyrrole, imidazole, furan, and thiophene rings. Some examples of heteroaromatic ring systems include indole, indazole, phenanthroline, benzimidazole, benzotriazole, purine, benzothiazole, carbazole, and 9-methylcarbazole. The photoacid may also contain any two of the foregoing rings and/or ring systems linked to each other (e.g., an indazole ring linked to a benzothiazole ring) by a linking group (e.g., a vinyl linker). Any of the rings described above may contain a substituent, such as hydroxy, alkoxy (e.g., methoxy or ethoxy), alkyl (e.g., methyl, ethyl, or isopropyl), alkenyl, amino, sulfonic acid (sulfonate), alkylsulfonate, nitro, carboxylic acid, ester, or halogen. For example, a benzene ring may be substituted with a hydroxy group to result in a phenol ring.

The structure of a particular reversible photoacid is shown as follows:

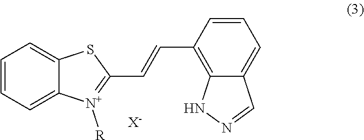

In Formula (3), R is typically an alkyl group (typically composed of only carbon and hydrogen atoms, with optional substitution with one or more F atoms) or an alkyl group containing (or more particularly, terminated in) a hydrophilic (water-solubilizing) group, such as a OH, COOH, ester, alkoxy, sulfonate, or nitro group. In the event that R does not possess a negative charge, an anion (X⁻), such as a halide (e.g., Cl⁻, Br⁻, or I⁻), is present as a counter ion of the cationic group in the formula. However, if R contains a negative charge (e.g., sulfate), X⁻ need not be present. Moreover, any one or both of the benzene rings shown in Formula (3) may or may not be independently substituted by one or more substituents described above. In some embodiments, one or more hydrogen atoms of the benzothiazole and/or indazole ring is/are substituted with one or an equivalent number of negatively charged groups as provided above, particularly one or more sulfonate groups or alkyl groups containing a sulfonate group. In separate or further embodiments, one or more hydrogen atoms of the benzothiazole and/or indazole ring is/are substituted with one or an equivalent number of ester groups, such as a carboxymethyl (—CO(O)CH₃) group.

The structure of another particular reversible photoacid is shown as follows:

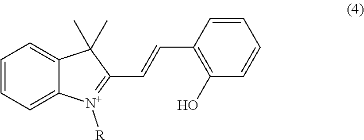

In Formula (4), R is typically an alkyl group (typically composed of only carbon and hydrogen atoms, with optional substitution with one or more F atoms) or an alkyl group containing (or more particularly, terminated in) a hydrophilic (water-solubilizing) group, such as a OH, COOH, ester, alkoxy, sulfonate, or nitro group. In the event that R does not possess a negative charge, an anion (X⁻), such as a halide (e.g., Cl⁻, Br⁻, or I⁻), is present as a counter ion of the cationic group in the formula. Moreover, any one or both of the benzene rings shown in Formula (4) may or may not be independently substituted by one or more substituents described above.

The structure of another particular reversible photoacid is shown as follows:

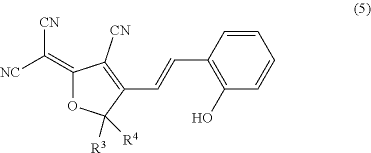

In Formula (5), R³ and R⁴ are typically an alkyl group (typically composed of only carbon and hydrogen atoms, with optional substitution with one or more F atoms) or an aromatic group, such as phenyl group. The benzene ring shown in Formula (5) may or may not be independently substituted by one or more substituents described above.

The reversible photoacid is present in the aqueous solution in any suitable concentration. Typically, the photoacid is present in the aqueous solution in a concentration of at least 0.1 mM. In different embodiments, the concentration of the photoacid in the aqueous solution is precisely or about, for example, 0.1, 0.2, 0.3, 0.4, 0.5, 0.6, 0.7, 0.8, 0.9, 1, 1.2, 1.5, 1.8, 2, 3, 4, 5, 6, 7, 8, 9, or 10 mM, or the concentration of the photoacid is within a range bounded by any two of the foregoing values, e.g., 0.1-10 mM, 0.2-10 mM, 0.5-10 mM, 1-10 mM, 1.5-10 mM, 2-10 mM, 0.1-5 mM, 0.2-5 mM, 0.5-5 mM, 1-5 mM, 1.5-5 mM, 2-5 mM, 0.1-2 mM, 0.2-2 mM, 0.5-2 mM, or 1-2 mM.

In a second step of the regeneration method, the aqueous solution is exposed to electromagnetic (EM) radiation having a wavelength or range of wavelengths that induces (stimulates) proton release from the photoacid and subsequent protonation of the bicarbonate, carbonate, or carbamate in the sorbent-CO₂ complex to result in release of CO₂ and water along with regeneration of the sorbent material in neutral form and uncomplexed to CO₂. The wavelength needed to stimulate release of a proton from the photoacid depends on the type of photoacid. The stimulating EM wavelength may be, for example, in the visible, ultraviolet, or infrared range, e.g., 300-800 nm, 350-800 nm, 400-800 nm, 300-700 nm, 350-700 nm, 400-700 nm, 300-600 nm, 350-600 nm, or 400-600 nm, depending on the type of photoacid. In some embodiments, the EM radiation is sunlight. In some embodiments, the wavelength that induces proton release from the photoacid is within the vicinity of or matches an absorbance wavelength of the photoacid. In some embodiments, the wavelength that induces proton release from the photoacid overlaps with an absorbance wavelength spectrum of the photoacid.

Generally, the pKa of the carbon dioxide sorbent is within the vicinity (i.e., approximately) the pKa of the reversible photoacid in the ground state to facilitate proton exchange between them and to avoid photoacid deprotonation in the absence of irradiation. The pKa of the sorbent is preferably within ±1, ±0.5, ±0.2, or ±0.1 of the pKa of the photoacid, and vice-versa. For example, if the pKa of the sorbent is precisely or about 8, the pKa of the photoacid is preferably precisely or about 7.5, 8, or 8.5. In some embodiments, the pKa of the sorbent matches the pKa of the photoacid.

In some embodiments, the method for regenerating a carbon dioxide sorbent, as described above, is integrated with a CO₂ production and capture process. In the CO₂ production and capture process, a gaseous source containing CO₂ is contacted with the CO₂ sorbent. Typically, the CO₂ is produced as an undesirable byproduct. The gaseous source can be, for example, air, waste gas from an industrial or commercial process, flue gas from a power plant, exhaust from an engine, or sewage or landfill gas. As discussed earlier above, the sorbent may be a liquid or a solid. Methods for capturing CO₂ from gaseous streams are well known in the art.

Examples have been set forth below for the purpose of illustration and to describe certain specific embodiments of the invention. However, the scope of this invention is not to be in any way limited by the examples set forth herein.

### Examples

### Overview

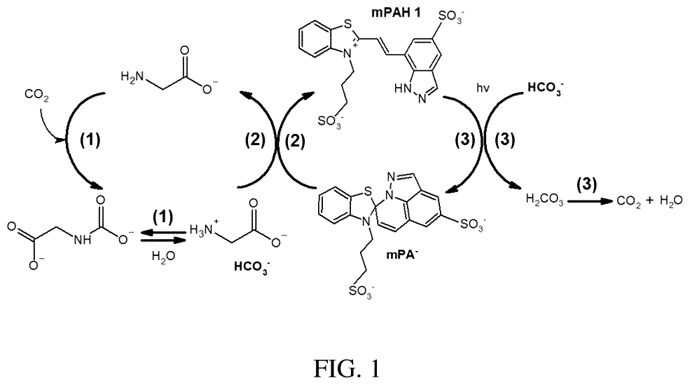

The concept of the presently described DAC approach is based on an AA sorbent and a mPAH driven photochemical release of CO₂. An exemplary process is depicted in FIG. 1. First, an aqueous AA solution (glycine shown), as sodium or potassium salt, reacts (in the presence of the photoacid in the same aqueous solution) with CO₂ from the air to form a mixture of carbamate, bicarbonate, carbonate anions, and zwitterionic AAs (AAzw). Second, upon photochemical activation, the mPAH 1 in an aqueous solvent mixture undergoes a series of photoinduced structural changes (PSCs) involving trans, cis, spiro, etc. isomers and concomitant intermolecular proton transfer to the solvent (water). These photoinduced events in turn shift the dynamic equilibria between carbamate, AAzw and bicarbonate. Finally, the subsequent proton transfer to the bicarbonate anion present in the system results in formation of carbonic acid (H₂CO₃), which is thermodynamically unstable and readily converts to CO₂ under ambient conditions. As the irradiation ceases, the mPAH 1 returns to its initial protonated trans form and the concomitant pH swing is expected to facilitate the regeneration of anionic state of AAs required for subsequent CO₂ capture cycles. It is important that the pKₐ of the AA (pKₐ=8-10) approximately matches the pKₐ of the mPAH 1 in the ground state to facilitate this proton exchange between them and also to avoid mPAH 1 deprotonation in the absence of irradiation.

The mPAH 1 photoacid was selected based on its unique properties. These include generation of high proton concentrations with high efficiency and good reversibility, very long-lived photogenerated acidic form, and photoactivation using moderate light intensity for intermolecular photon transfer and PSCs. These unique properties make such a mPAH an ideal candidate for photoinduced CO₂ release processes with sustainable solar light. Since the present DAC concept involves proton transfer from photoexcited mPAH 1 molecules to bicarbonate anions to form H₂CO₃, subsequent decomposition of H₂CO₃ leading to CO₂ release will result in the gradual increase of the solution pH. Thus, monitoring the pH in real time will provide a straightforward means to gauge this photochemically-driven CO₂ release.

### Experimental Methods

Synthesis of mPAH 1: Synthesis of 3-(3-sulfonatopropyl)-2-methyl-benzothiazolium was previously reported (A. Elgattar et al., J. Photochem. Photobiol. A: Chem. 2023, 439, 114599). The benzothiazolium (0.50 g, 1.84 mmol) was dissolved in minimum EtOH:H₂O (5:1). Synthesized sodium 7-formyl-1-H-indazole-5-sulfonate (0.59 g, 2.37 mmol) was added to the solution. Then the mixture was refluxed overnight. After allowing the mixture to cool to room temperature, the yellow solid precipitate was filtered and washed with cold EtOH. The crude product was purified by adding ethanol to a concentrated aqueous solution to yield the orange final product (0.50 g, 55%).

CO₂ loading: The CO₂ absorption from air by a 0.1 M solution of glycine+KOH was realized using an air humidifier, as previously demonstrated, and was diluted to required concentrations. See F. M. Brethome et al., Nat. Energy 2018, 3, 553-559 and R. Custelcean et al., Ind. Eng. Chem. Res. 2019, 58, 23338-23346.

Light sources: The light source, referred as the 355 nm lamp thereafter, is a portion of the output of an Oriel 200 W mercury-xenon lamp, which was selected using a 2″ round Oriel broadband filter centered at 355 nm with a full width at half maximum of ˜150 nm and highest transmission of ˜90% (Filters 51664 and 59814). The photon fluxes at the sample position was ˜500 μmol·m⁻²·s⁻¹, which measured using a handheld meter.

pH measurements and absorption spectra measurements: Typically for all experiments using the 355 nm lamp, 6 mL of solution mixtures were placed in a glass vial of diameter ˜2 cm and pH variations of the solutions upon light exposure were monitored continuously using a pH meter. Solutions were exposed to air and continuously stirred during pH measurements and sealed and kept in the dark without stirring for the mPAH 1 reverse reaction. Calculated amount of bicarbonate was replaced prior to second and third cycles. All absorption spectra during a given reaction event were acquired using a UV-vis spectrometer by taking a small amount (˜200 μL) of solution. Co-existence of different mPAH 1 conformers were verified using 1H NMR spectroscopy and theoretical calculations.

Gaseous CO₂ detection: Released gaseous CO₂ content present in the headspace of a closed vial (50 mL 3-necked flask) was detected using a sampling CO₂ meter. 40 mL of 1 mM mPAH 1 and 1 mM KHCO₃ (or glycine/CO₂) was placed inside the flask and N2 was purged into the headspace (not through the solution) for 30 minutes and then the solution was stirred in dark (for 1-2 hours) before irradiating with the 355 nm lamp. Data were recorded at 1-minute intervals using commercial software during the entire process.

Total inorganic carbon analysis: To quantify the amount of total inorganic carbon converted to CO₂, the quantities of bicarbonate in the solution before and after the irradiation were determined using a total inorganic carbon analyzer consisting of an acidification module and a coulometric detection. 5 mL of 2 M HCl acid was dispensed to acidify: 1) 9 mL of sample of interest (1 mM KHCO₃ and 1 mM glycine/CO₂) and 2) 1 mL of 20 mM glycine/CO₂ sample. Air was used as carrier gas (100 mL/min) in all experiments. 1 mM KHCO₃ solution was tested similarly as the reference sample. Calculations were based on sample volume and 1 M Na₂CO₃ was used as the standard solution.

Thermogravimetric analysis-mass spectrometry (TGA-MS) measurements: To quantify the amount of CO₂ present in solutions, 1 mM mPAH 1 and 1 mM KHCO₃ samples that include one as prepared (control), one reacted in dark (stirred for 1 hour exposed to air), and one irradiated with the 355 nm lamp (stirred for 1 hour exposed to air at the same time as the dark reaction) were analyzed using TGA-MS.

NMR spectroscopy: ¹³C NMR measurements were performed with 20 mM mPAH 1 (prepared in D₂O) and 20 mM glycine/CO₂ (0.1 M CO₂ loaded sample under DAC conditions diluted with D₂O) before and after irradiation using a 400 MHz NMR spectrometer equipped with a 5 mm PABBI probe. The relaxation delay was set to 50 s using a full 90° pulse for excitation with power gated ¹H decoupling. The 355 nm lamp was used for irradiation. All NMR data were processed using commercial software.

### Discussion

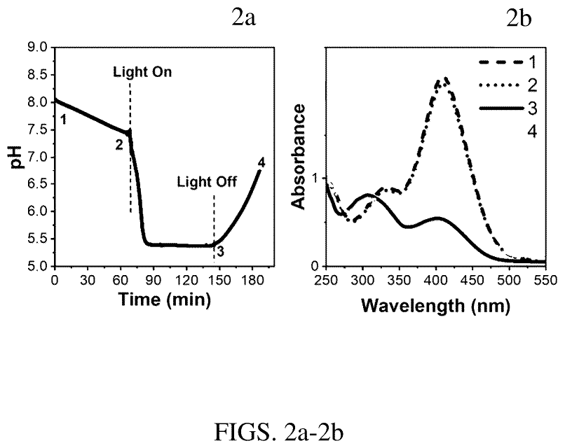

The limits of pH change, photostability and reversibility of mPAH 1 were first tested at 1 mM concentrations in water upon irradiation with the 355 nm lamp over prolonged timescales. FIG. 2a shows these pH measurements as a function of time, wherein a drop of ˜2 pH units was observed within the first 15 minutes, after which the pH remained unchanged over the course of irradiation. Upon blocking the light source, mPAH 1 gradually returned to its initial trans form and the pH correspondingly increases.

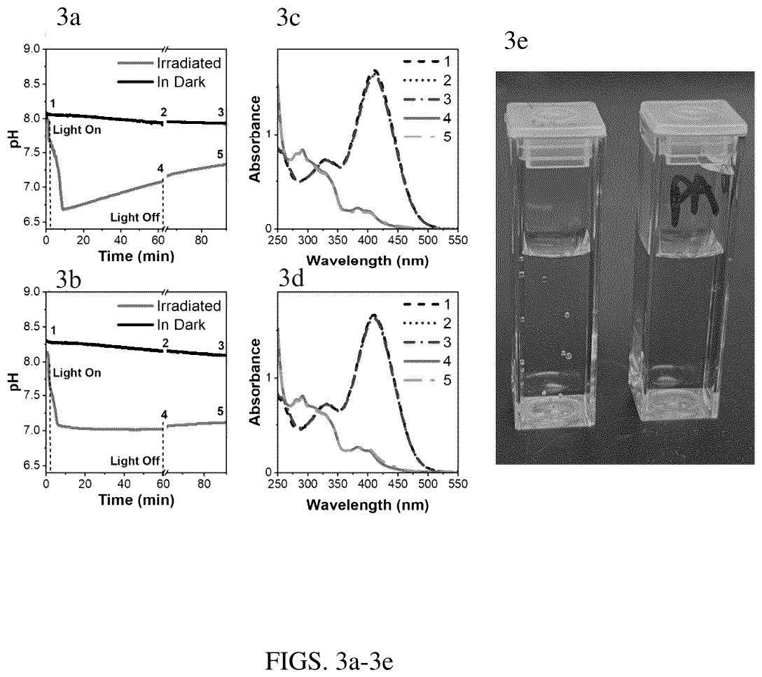

To examine the acid-base chemistry of mPAH 1, pH measurements were performed on different mixtures containing mPAH, and the representative results are summarized in FIGS. 3a-3d. First, it was determined whether the pH swing induced by the mPAH irradiation in weakly basic environments is sufficient for triggering CO₂ release. Here, an aqueous solution containing 1 mM mPAH 1 and 1 mM potassium bicarbonate (KHCO₃) was selected as a simulated CO₂-loaded system. The bicarbonate containing system was focused on to test the feasibility of mPAH 1 for CO₂ release, since bicarbonate is the most common and dominant product in DAC process based on strong bases and AAs. A pH increase of ˜0.4 units at ˜85 min was observed following the initial photo-driven pH drop of ˜1 unit, as shown by the gray curve in FIG. 3a. This pH increase is in striking contrast to the constant pH observed for the reference solution containing 1 mM imidazole and 1 mM mPAH 1 shown in FIG. 3b. As a weak base, imidazole serves as a proton acceptor, which renders this reference system free of CO₂. Irradiation of the reference solution results in a pH drop from 8.1 to 7.0, which remained unchanged until the lamp was turned off, where a slight increase in pH was observed due to the reverse reaction of the photoexcited mPAH 1 back to its initial trans form. The pH increase observed for the simulated system containing 1 mM mPAH 1 and 1 mM KHCO₃ (FIG. 3a) represents indirect evidence for the feasibility of a photochemically-driven CO₂ release.

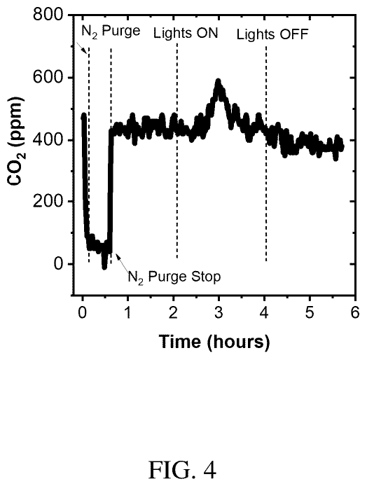

An intuitive view of this CO₂ release is further provided by the photograph in FIG. 3c, where CO₂ formation in an air-tight cuvette containing aqueous solution of 1 mM mPAH 1 and 1 mM KHCO₃ lead to clearly visible bubbles (gaseous CO₂) after light exposure, but no bubbles are seen in the aqueous solution containing only mPAH 1. Validation of this conclusion is first made by observation of an increase in the CO₂ content in the headspace of the vial upon irradiation (FIG. 4). To quantify the amount of CO₂ released, total inorganic carbon analysis and TGA-MS was used. As shown in Table 1 (below), total inorganic carbon analysis using coulometric titration shows that ˜55% of the total inorganic carbon available in the solution was converted to CO₂ upon mPAH 1 irradiation. Furthermore, TGA-MS measurement was performed to quantify the amount of CO₂ present in a solution of 1 mM KHCO₃ and 1 mM mPAH 1. The control sample (as prepared) contained dissolved CO₂ that results in a weight loss of 1.0% upon TGA analysis due to CO₂ as confirmed by the MS. When the sample was exposed to air and reacted under dark conditions, the weight loss percentage of dissolved CO₂ was 1.8%, and for the photo-irradiated sample it was 1.5%. Since the reaction was performed under air exposure to be compatible with other measurements reported, an increase in the amount of CO₂ present was observed in reacted samples (either in dark or under irradiation) compared to the control (as prepared sample). Both the increase in gaseous CO₂ in the headspace and decrease in total inorganic carbon content and dissolved CO₂ in the reaction samples upon irradiation confirm the release of CO₂ from the simulated system. These findings substantiate that the pH increase observed for the mPAH 1+KHCO₃ simulated system under irradiation indeed resulted from CO₂ release.

TABLE 1
Total inorganic carbon (TIC) analysis for quantification
of the amount of CO₂ released

| | | Amount of bicarbonate |
|---|---|---|
| # | Sample | in the solution (mg/L) |
| 1 | 1 mM KHCO₃ | 11.42 ± 0.22 |
| 2 | 1 mM mPAH 1 + 1 mM KHCO₃ | 12.02 ± 0.03 |
| | Before irradiation | |
| 3 | 1 mM mPAH 1 + 1 mM KHCO₃ | 5.12 ± 0.19 |
| | After irradiation | |
| 4 | 2 mM mPAH 1 irradiated (10 mL), | 11.60 ± 0.25 |
| | added 2 mM KHCO₂ (10 mL)- | |
| | Reaction in dark | |
| 5 | 2 mM mPAH 1 irradiated (10 mL), | 5.43 ± 0.00 |
| | added 2 mM KHCO₂ (10 mL)- | |
| | Reaction under irradiation | |

*All samples prepared for the TIC analysis contained 20 mL of the respective mixtures. The pH increase that corresponds to CO₂ release for 20 mL of sample# 3 and 5 was 0.008/min. 9 mL of sample was used for each TIC trial. A significant reduction of bicarbonate in the solution resulting from CO₂ release was observed only when the mixture was under continuous irradiation.

It should be noted that the pH increase is observed during and after ceasing irradiation, but the underlying mechanisms are fundamentally different. The former corresponds to decomposition of carbonic acid leading to CO₂ release, whereas the latter arises from mPAH 1 reverse reaction, which was also observed in mPAH 1 alone and the mPAH 1+imidazole systems, as shown in FIGS. 2a and 3b.

Realization of this photochemically-driven CO₂ release at a macroscopic scale is typically only feasible when a sufficiently high concentration of protons is generated and maintained in the aqueous solution so that a macroscopic quantity of carbonic acid can be formed. This critical requirement can be readily met with the mPAH 1, allowing to facilitate bulk CO₂ release under much lower concentrations of photoacid, KHCO₃ and AAs as shown below. This is evidenced by not only the findings described above but also a remarkable effect of continuous irradiation on CO₂ release. When an aqueous solution of 2 mM mPAH 1 was first irradiated for 30 minutes to reach a pH value of 5.2 and then immediately mixed with an equivalent volume of aqueous solution of 2 mM KHCO₃ in darkness, it was herein found that only ˜3% of the total bicarbonate was converted to CO₂ during the subsequent reaction without irradiation. In contrast, when the same experiment was repeated under continuous irradiation, it was determined that ˜50% of the total bicarbonate in the mixture was converted to CO₂ (see Table 1). This observation suggests a potential means for achieving on-demand CO₂ release by simply controlling the irradiation time, which would be beneficial in the context of CO₂ storage and conversion into value-added products.

Since the deprotonation reaction takes place after a series of PSC processes and the resulting neutral and deprotonated isomers are characterized by very different absorption spectra, this offers a straightforward means to assess the existence of long-lived isomers by simply acquiring absorption spectra of the reaction solutions at different time points during illumination. FIGS. 3c and 3d show the absorption spectra acquired for the samples containing 1 mM mPAH 1 and 1 mM KHCO₃, or 1 mM mPAH 1 and 1 mM imidazole, respectively, where the trans form is identified as the dominant species prior to illumination (corresponding to numberings 1, 2, and 3). Upon illumination, the absorption spectra of both solutions acquire features characteristic of the spiro isomer, a closed ring form of the deprotonated mPAH 1, along with two additional peaks at ˜382 and ˜401 nm potentially arising from the protonated cis form of the mPAH 1. Note that these spectra are different from those recorded for an aqueous solution of mPAH 1 alone at different irradiation times, which are given in FIG. 2b, suggesting that the type of isomer and their relative proportions are very sensitive to the solution compositions. This provides a means to not only drive off CO₂, but also monitor the state of the DAC system in situ, which is important to the applications at a technology relevant scale.

An essential property of a photochemically driven DAC is the recyclability of the photoacid. For the current system, this would require that the mPAH 1 deprotonation and accompanying reactions are reversible and the mPAH 1 can be recycled in subsequent DAC cycles. While the reverse reaction of mPAH 1 itself to the initial trans isomer is efficient and can be fully completed within 4-6 hours, the presence of a weak base in the mPAH 1 solution prevents its full recovery to the trans form after the solution was kept in the dark for an extended time. As a result, a mixture of trans and spiro forms with resolvable peaks at ˜290, ˜330, and 411 nm is observed (see FIG. 3c). However, even with this partial reversibility, a second and a third cycles of irradiation on the simulated system of 1 mM mPAH 1 and 1 mM KHCO₃ resulted in pH increases of ˜0.4 units (0.35 pH units/hour) and ˜0.3 units (0.11 pH units/hour), respectively, owing to CO₂ release.

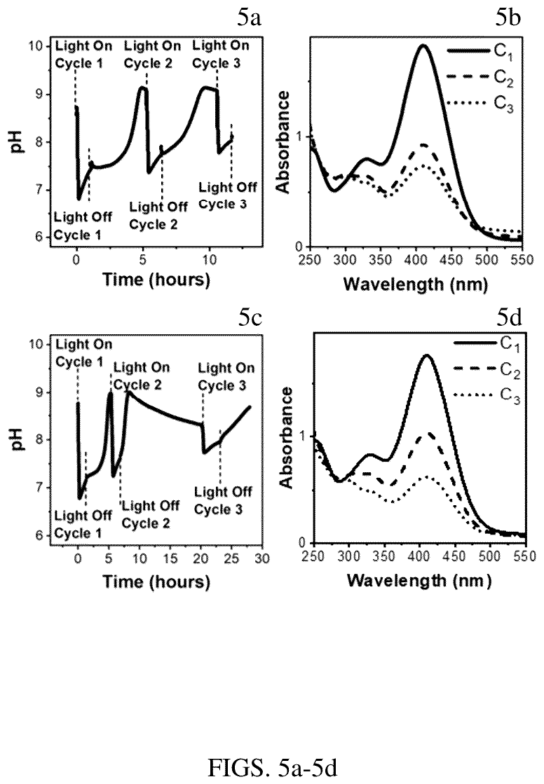

FIGS. 5a-5d show the pH variation of these three subsequent cycles, along with the absorption spectra taken right before each irradiation cycle. Although recovery of the initial trans form cannot be fully realized within 2 to 4 hours, it was herein found that a prolonged waiting time (12-24 hours) after irradiation caused a slight drop of pH (demonstrated here for the second cycle). If the third cycle of CO₂ release is performed only 4 hours after the second cycle, a higher pH increment of 0.31 pH units/hour was herein observed, as shown in FIG. 5a. The absorption spectra taken over the course of the reverse reaction process further show clearly that this extended waiting time yielded an equilibrated mixture of slightly different isomer compositions. The results shown in FIGS. 5a-5d confirm that recovery of the trans state occurs simply by ceasing irradiation and this recyclability is ample for subsequent CO₂ release cycles, which can be performed after short periods of equilibration time. This finding holds true for solutions containing high bicarbonate concentrations as well; for instance, a simulated system with a mPAH 1: bicarbonate ratio of 1:10, the weakly acidic trans form can still be recovered in the dark and is thus usable in subsequent release cycles.

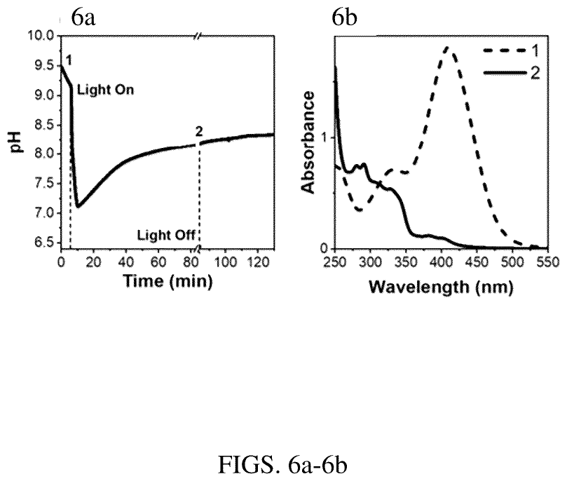

Finally, measurements were conducted on an aqueous solution containing 1 mM mPAH 1 and 1 mM CO₂-loaded glycine/KOH. Upon illumination for 60 minutes, a pH increase of 1.05 pH units was observed as shown in FIGS. 6a and 6b, which is clearly different from the changes found for the simulated systems seen in FIG. 3a. Besides the differences in magnitude, the pH increases with time further proceeds in distinct manners as well. Specifically, for the simulated system, the pH increase follows approximately a linear behaviour (FIG. 3a). The pH change observed for the CO₂-loaded glycine/KOH system appears substantially different from that observed for the simulated systems, manifested by an initial linear trend and subsequently a sublinear growth over the 60-minute time period.

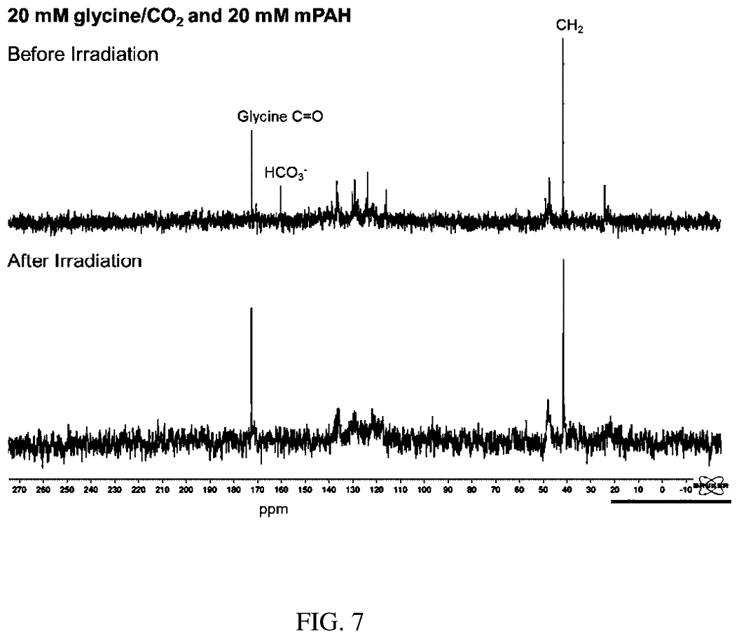

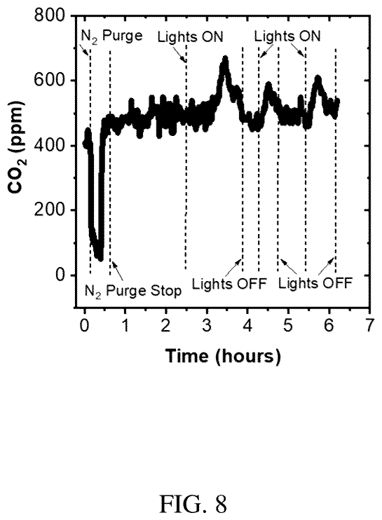

The resulting CO₂ release was confirmed using NMR spectroscopy, total inorganic carbon analysis, and gaseous CO₂ detection. First, ¹³C NMR spectra was acquired from a mixture containing 20 mM mPAH 1 and 20 mM CO₂ loaded glycine, as 1 mM concentration of such a mixture is simply too low for NMR detection. As shown in FIG. 7, a comparison of the NMR spectra acquired before and after irradiation shows that the peak corresponding to HCO₃ becomes negligible after irradiation. Second, the total inorganic carbon analysis of 1 mM and 20 mM mixtures of CO₂-loaded glycine and mPAH 1 shows a reduction in the inorganic carbon content by approximately 68% and 78%, respectively, upon irradiation with respect to the corresponding CO₂-loaded glycine solutions as summarized in Table 2 (below). Third, gaseous CO₂ detection from the headspace of a reactor containing a mixture of CO₂ loaded 1 mM glycine and 1 mM mPAH 1 exhibits a clear increase in the CO₂ content upon irradiation in three repeated cycles (FIG. 8).

TABLE 2
Total inorganic carbon (TIC) analysis for quantification
of the amount of CO₂ released.

| | | Amount of Total |
|---|---|---|
| | | Ionizable Carbon |
| # | Sample | (mg/L) |
| 1 | 20 mM glycine/CO₂ | 142.7 ± 0.2 |
| 2 | 20 mM glycine/CO₂ + 20 mM mPAH 1 | 31.6 ± 1.4 |
| | After irradiation | |
| 3 | 1 mM glycine/CO₂ | 1.44 |
| 4 | 1 mM glycine/CO₂ + 1 mM mPAH 1 | 0.46 |
| | After irradiation | |

*1 mL of sample was used for each TIC trial with 20 mM glycine/CO₂ system and 9 mL was used for 1 mM glycine/CO₂ sample.

The distinct behavior of the pH change as a function of light exposure time for the 1 mM mPAH 1 and 1 mM CO₂-loaded glycine solution (FIGS. 6a-6b) compared to the bicarbonate only systems (FIG. 3a) warrants further discussion. As this AA-CO₂ system involves multiple species, such as carbamates, bicarbonates, carbonates, AA⁻, and AA_{zw}, their reaction equilibria are expected to vary constantly with time during a given reaction cycle. Detangling the complex reaction equilibria and identifying the major reaction pathways, especially on how concentration of each species would change over the course of the reaction, is challenging for the low concentration ranges described in this work. Nevertheless, the photochemical reaction clearly leads to a reduction of the amount of CO₂ in solution as either bicarbonate or carbamate, which is evidenced from the total inorganic carbon analysis and ¹³C NMR measurements (Table 2 and FIG. 7, respectively).

As mentioned earlier, occurrence of the CO₂ release in the mPAH 1 and AA system depends critically on the match between the pKₐ of the AAs and the pKₐ of the photoacid in the ground state. Moreover, it is important to maintain a suitable concentration ratio between the mPAH 1 and glycine/KOH solutions in order to trigger the CO₂ release. Because the AA itself acts as a buffer, the deprotonation of the mPAH 1 cannot significantly alter the bulk pH unless the concentration of mPAH 1 is comparable or greater than to that of the glycine/CO₂ system. Therefore, when similar experiments were conducted with higher concentrations of the glycine/CO₂ solutions (10 mM and 0.1 M), no detectable pH change was observed, whereas for a mPAH 1/AA concentration ratio of 2:1, a similar pH increase was observed.

Experiments Using Sulfonated Indazole Photoacid (mPAH 2)

Although the indazole photoacid described above was effective, there are two non-optimal aspects of the indazole photoacid. First, its photoreaction often generates a significant portion of the cis-isomer instead of the spiro (SP) isomer. Since the cis isomer is less acidic than SP, the effective photoacidity is reduced. Second, the rigid conjugated structure leads to low solubility, especially in water.

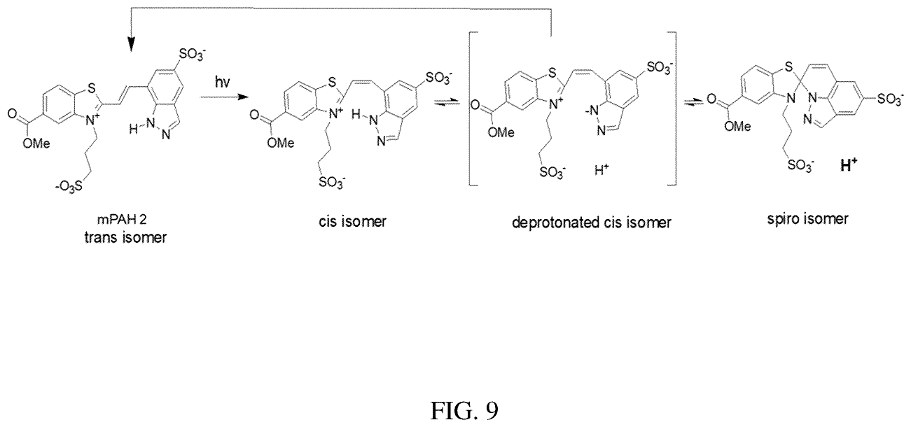

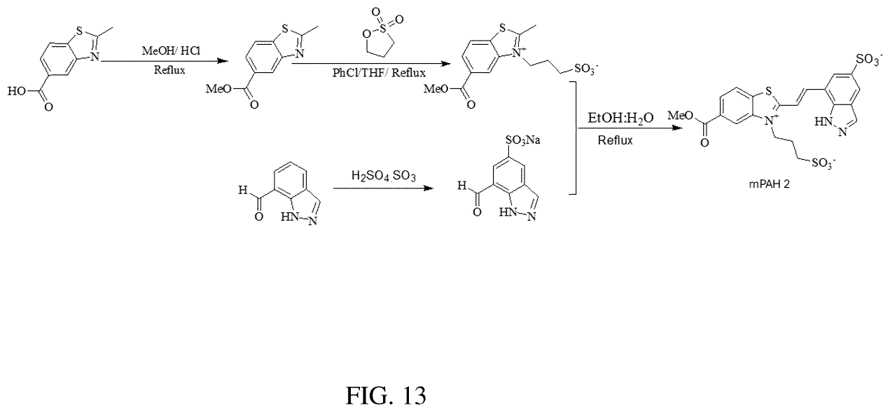

mPAH 2 (FIG. 9) was designed to solve these problems. It possesses a SO₃⁻ substituent on the indazole moiety, which greatly enhances its solubility in water. For comparison, the indazole photoacid without this SO₃⁻ substituent is essentially insoluble in water, while the solubility of mPAH 2 in water is about 30 mM. An ester group was added to the benzothiazolium side. This electron withdrawing group reduces the electron density on the reactive carbon, and thus encourages the nucleophilic cyclization reaction, which forms the high-acidity SP. mPAH 2 was prepared from indazole-7-aldehyde and 2-methyl-benzothiazole-5-carboxylic acid. Indazole-7-aldehyde was sulfonated using a literature procedure (A. Elgattar et al., Journal of Photochemistry and Photobiology A: Chemistry, 439, 114599). The synthetic process is depicted in FIG. 13. As shown in FIG. 13, the methyl ester of benzothiazolium sulfonate was synthesized from the benzothiazole carboxylic acid in two steps. The aldehyde was then coupled with the benzothiazolium by a Knoevenagel reaction. The orange precipitate was recrystalized in water/ethanol to yield the final product-mPAH 2.

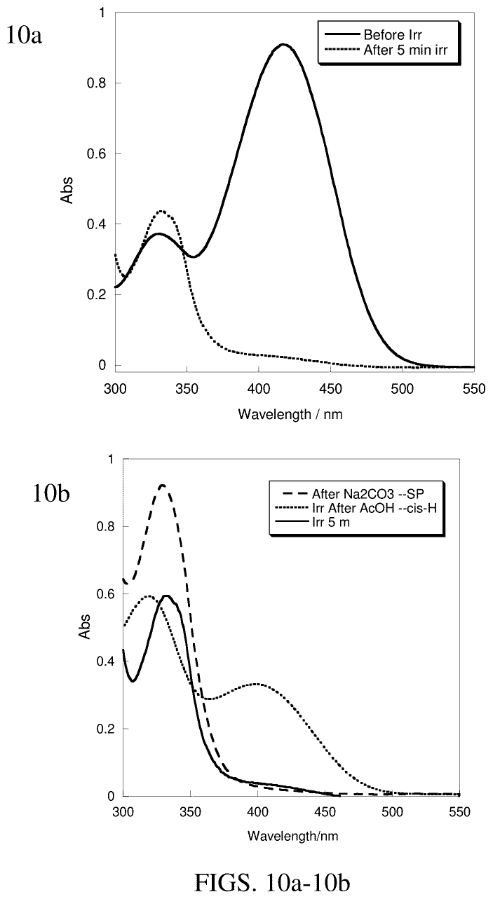

The photoreaction of mPAH 2 in aqueous solution was studied by UV-Vis absorption spectroscopy. FIG. 10a shows absorption spectra of mPAH 2 in water before and after irradiation. FIG. 10b shows absorption spectra of the photoproduct of mPAH 2, in acetic acid solution (cis-H), and SP generated by addition of base. As shown in FIGS. 10a and 10b, mPAH 2 has an absorption band in visible range with a λₘₐₓ at 415 nm. Upon irradiation with a 470 nm LED, the band decreased close to baseline, and a band peaked at 332 nm raised. As indicated in Elgattar et al. (Ibid.), an indazole photoacid without the ester group showed that the major photoproduct in aqueous solution without any base was the cis isomer. The absorption band of the cis isomer has a shoulder in the visible range, while the SP does not absorb in the visible range. The fact that the photoproduct of mPAH 2 showed little absorption in the visible range indicates that the major product is SP. To confirm this, the SP was generated by adding a drop of concentrated Na₂CO₃ to a solution of mPAH 2. Addition of a strong base is a routine method to generate the SP form of a metastable state photoacid. As shown in FIG. 10b, the shape of the SP absorption band is close to that of the photoproduct of mPAH 2. The absorption spectrum of the photoproduct was also compared with that of the cis isomer. Elgattar et al. (Ibid.) showed that both cis-to-SP and cis-to-trans reactions have the deprotonated cis isomer as the major intermediate. Under an acidic condition, the cis isomer is stabilized due to protonation. Thus, the cis isomer was generated by irradiating a solution of mPAH 2 mixed with acetic acid. Comparing the absorption spectra of cis, SP, and the photoproduct (FIG. 10b) shows that the photoproduct was mostly SP, which was mixed with a small portion of the cis isomer. This result shows that addition of an electron-withdrawing ester group on the benzothiazolium moiety indeed encourages the formation of SP.

The capability of changing pH with mPAH 2 was tested by measuring the pH of a 1 mM solution of mPAH 2 in distilled water. The initial pH was 6.55, which is in the common pH range of distilled water. Irradiating the sample with a 470 nm LED for 5 minutes reduced the pH to 3.88, which is 2.67 unit lower than the original pH. Keeping the sample in the dark after irradiation reversed the pH back to original level (6.47) in 45 minutes.

Given the promising properties of mPAH 2, its capability to induce CO₂ release from a sorbent was studied. Amines are commonly used sorbents for CO₂ capture. Morpholine is a secondary amine, which has been identified as a promising sorbent due to its high reactivity with CO₂ and relatively low stripper temperature. In this study, morpholine was selected mostly because of the relatively low pKa (8.5) of its protonated form comparing to other commonly used amines, such as ethanolamine (pKa=9.5). The pKa of the amine must be lower or close to that of the photoacid in the dark. If the pKa of the amine is too high, the photoacid will transfer proton to the amine without irradiation, which results in the formation of ammonium salt with less basicity than that of the amine and decreases the capability of CO₂ capture.

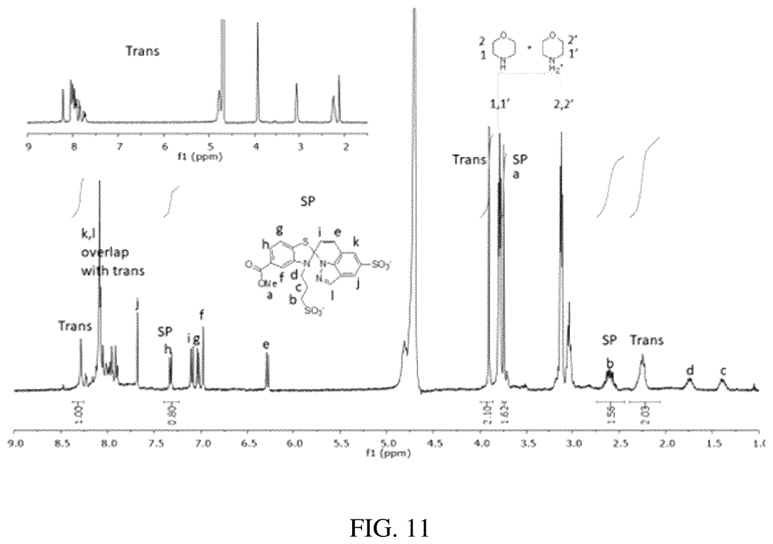

To study the proton transfer between mPAH 2 and morpholine in the dark, a 1:1 morpholine/mPAH 2 solution was studied by NMR. The concentration of both was 10 mM. NMR analysis, as shown in FIG. 11, showed that 4/9 of mPAH 2 changed to the acidic SP due to proton transfer to morpholine. The other 5/9 kept the protonated trans conformation. The chemical shifts of the morpholine peaks are between that of morpholine and protonated morpholine, which confirms the partial protonation of morpholine. This result indicates that mPAH 2 can hold most of its protons in the presence of morpholine in the dark although a portion of mPAH 2 transferred protons to morpholine.

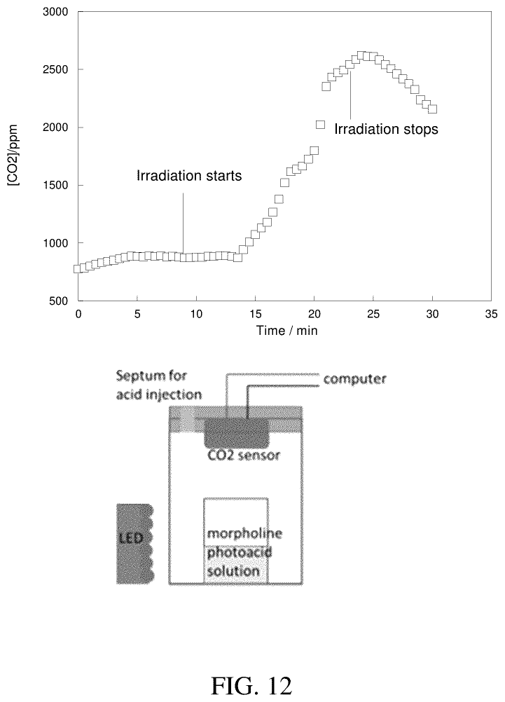

The mixture was loaded with CO₂ by gently bubbling CO₂ through a 3 mL solution of the mixture for two minutes. It was then left open in air for 1 h to achieve a pseudo equilibrium state with air. This step is important to reproducibly measure the CO₂ release as described below. As indicated in FIG. 12, the sample was then transferred to a glass chamber with an infrared sensor. After the reading of CO₂ was steady, irradiation was applied from outside of the glass chamber using a 470 nm LED with moderate power (˜ 13 mW/cm²). The CO₂ released to the chamber was monitored using a head space method, as also used in previous studies. The concentration of CO₂ gas in the chamber was monitored by the sensor and compared to that of a standard. Not only does this method directly measure the CO₂ gas released, but also it is suitable for studying relatively small samples with good sensitivity.

As shown in FIG. 12, the reading of [CO₂] in the head space raised up ˜ 5 minutes after the irradiation started. The delay is due to the time required for the photoreaction as well as accumulation and diffusion of CO₂ for the detection by the sensor, which is located on the cap of the chamber. The irradiation lasted for 15 min and the concentration of CO₂ in the head space increased by 1.74×10³ ppm maximumly (FIG. 12). Prolonged irradiation did not lead to more CO₂ release. The concentration slowly decreased after the irradiation was removed due to reabsorption of CO₂ by the solution and maybe leakage of the chamber.

The pH of the solution in an open container before CO₂ loading, after CO₂ loading, and immediately after irradiation were measured to be 7.6, 6.0, and 5.5 respectively. Notably, the pH measured immediately after irradiation, i.e. 5.5, may not represent the maximum pH drop in the process. This is because CO₂ was released during irradiation, which resulted in pH increase. So, the maximum pH drop occurred during the irradiation. However, the pH meter was not capable of following the quick pH change during the irradiation. As described below, the pH drop is enough to release essentially all of the CO₂ captured. After the irradiation, the photoacid reversed back to the less acidic trans-isomer, which led to pH increase and regeneration of non-protonated morpholine. In fact, the pH recovered to 7.5, which is close to the initial value before CO₂ loading, 20 minutes after irradiation.

The regeneration of the sorbent was demonstrated by repeatedly loading CO₂ to the sample followed by irradiation using the same procedure as in the first cycle. The release of CO₂ in the 2nd cycle (1.57×10³ ppm) was close to that of the first cycle. The CO₂ release in the third cycle was 1.50×10³ ppm. The decrease of CO₂ release in the 2nd and 3rd cycle is likely due to evaporation of morpholine during the CO₂ loading and equilibrating steps in each cycle.

The amount of CO₂ release was compared to that of an aqueous solution with the same amount of NaHCO₃ as that of morpholine. The decomposition of NaHCO₃ was induced by injection of a concentrated HCl solution through a septum on the chamber. Addition of a strong acid leads to complete decomposition of the bicarbonate and CO₂ release. The CO₂ released was 5.17×10³ ppm. The less amount of CO₂ release from the mixture of morpholine and mPAH 2 is mainly due to less CO₂ captured than the amount of NaHCO₃. Morpholine can capture CO₂ by forming carbamate salt, in which case the ratio between morpholine and CO₂ is 2:1. It also reacts with CO₂ via an acid-base reaction to form bicarbonate salt. Although the ratio between morpholine and CO₂ is 1:1, the bicarbonate is less stable than the carbamate.

Under ambient condition, the bicarbonate forms an equilibrium with free morpholine in the solution and CO₂ in air. For the concentration (10 mM) used for this study, bicarbonate is the predominate form. The CO₂ captured was less than the amount of morpholine due to the equilibrium. To prove this, HCl was added to the mPAH 2/morpholine solution after it was loaded with CO₂. The CO₂ released was 1.77×10³ ppm. For comparison, the CO₂ released under irradiation is 1.74×10³ ppm. This result shows that nearly all the CO₂ captured was released by irradiation.

In summary, it has herein been shown that the photoactivity, acidity and solubility of a photoacid can be tuned for CO₂ release from its sorbent. mPAH 2 was paired with morpholine, which is a well-studied amine for CO₂ capture. The results show that a mixture of mPAH 2 and morpholine in aqueous solution can repeatedly capture and release CO₂ under moderate irradiation of visible light. The CO₂ released is close to that which was captured, which indicates the high efficiency of the photo-induced release.

While there have been shown and described what are at present considered the preferred embodiments of the invention, those skilled in the art may make various changes and modifications which remain within the scope of the invention defined by the appended claims.

What is claimed is:

1. A method for regenerating a carbon dioxide (CO₂) sorbent material, the method comprising:
(i) contacting a sorbent-CO₂ complex in aqueous solution with a reversible photoacid, wherein the CO₂ in the sorbent-CO₂ complex is in the form of bicarbonate, carbonate, or carbamate; and
(ii) exposing the aqueous solution to electromagnetic radiation having a wavelength that induces proton release from the photoacid and subsequent protonation of the bicarbonate, carbonate, or carbamate in the sorbent-CO₂ complex to result in release of CO₂ and water and regeneration of the sorbent material.

2. The method of claim 1, wherein the sorbent material is an amine-containing sorbent material.

3. The method of claim 2, wherein the amine-containing sorbent material is an amino acid.

4. The method of claim 3, wherein the amino acid is glycine.

5. The method of claim 2, wherein the amine-containing sorbent material is an alkylamine.

6. The method of claim 2, wherein the amine-containing sorbent material is an alkanolamine.

7. The method of claim 1, wherein the sorbent material is an alkali hydroxide.

8. The method of claim 1, wherein the electromagnetic radiation comprises a visible wavelength.

9. The method of claim 1, wherein the electromagnetic radiation comprises an ultraviolet wavelength.

10. The method of claim 1, wherein the electromagnetic radiation is sunlight.

11. The method of claim 1, wherein the reversible photoacid contains at least one heteroaromatic ring or fused ring system.

12. The method of claim 11, wherein the heteroaromatic ring or fused ring system comprises an indazole ring system.

13. The method of claim 1, wherein the reversible photoacid is present in the aqueous solution in a concentration of 0.1-10 mM concentration.

14. The method of claim 1, wherein the reversible photoacid is present in the aqueous solution in a concentration of 0.1-5 mM concentration.

15. The method of claim 1, wherein the reversible photoacid is present in the aqueous solution in a concentration of 0.5-2 mM concentration.

16. The method of claim 1, wherein the regenerated sorbent material is re-used to capture CO₂.

17. The method of claim 1, wherein the method for regenerating carbon dioxide is integrated with a CO₂ capture process.

18. The method of claim 1, wherein the pKa of the carbon dioxide sorbent is approximately the pKa of the reversible photoacid.

19. The method of claim 1, wherein the wavelength that induces proton release from the photoacid matches an absorbance wavelength of the photoacid.

20. The method of claim 1, wherein the reversible photoacid is a reversible metastable-state photoacid.

21. The method of claim 1, wherein, further comprising, before step (i), producing the sorbent-CO₂ complex by contacting an aqueous solution containing the sorbent with a gaseous source containing CO₂, wherein the reversible photoacid may be present in the aqueous solution during production of the sorbent-CO₂ complex or added to the aqueous solution or vice-versa after production of the sorbent-CO₂ complex.

22. The method claim 1, wherein step (i) of the method comprises contacting an aqueous solution containing the sorbent and reversible photoacid with a gaseous source containing CO₂ to produce the sorbent-CO₂ complex in aqueous solution while in the presence of the reversible photoacid.
